(19) United States
(12) Patent Application Publication
(10) Pub. No.: US 2004/0217242 A1
(43) Pub. Date: Nov. 4, 2004

(54) Ladder workstation and attachment bracket

(76) Inventor: Alexander Joseph Foreman, Torquay (GB)

Correspondence Address: ALEX FOREMAN, ORMONDE COTTAGE, 15 NEWTON ROAD, TORQUAY, DEVON, TQ2 5DB, GB

(21) Appl. No.: 10/427,407

(22) Filed: May 2, 2003

(51) Int. Cl. E06C 7/14

(52) U.S. Cl. 248/210

(57) ABSTRACT

A utility workstation is attached to a ladder upright locating into a self-attaching bracket. The bracket is movable in a one handed operation and will locate on either side of ladder uprights. There are no screws, wires or clamps required to position the bracket. The bracket compensates for the correct safe working position of a ladder at 4 in 1 and holds the workstation in a level position to the ground, on a single or double section of ladder. The workstation contains removable open rectangular inserts to hold paint materials and/or work utensils. Additionally the inserts will receive rectangular liners and attachable paint roller tray. These liners are open and compartmented to contain paint materials and/or work utensils. The workstation will free stand on the ground.

This invention relates to a ladder caddy to support paint materials and various tools; more particularly to an improved clasp that requires no screws, clamps or springs to locate on either side of ladder uprights in general.

### BACKGROUND OF THE INVENTION

This invention relates to improvements to detachable ladder workstations to support paint materials and various tools.

In the past various approaches have been taken to provide releasable and movable ladder workstations.

For example U.S. Pat. No. 1,087,603 to C Nellis issued Feb. 17, 1914 discloses a sprung loaded clamp that attaches to the narrow side of ladder uprights in general. Similarly U.S. Pat. No. 2,990,152 to J. Hall issued Jun. 5, 1999 employs a bracket that attaches to ladder uprights and utilises weight for a locking mechanism, this device being employable for single ladder uprights in general.

Both of these above caddies are all one-piece design and separate from their ladder attachment brackets by means of a wing nut or screws. Similarly U.S. Pat. No. 5,236,161 to R Haven issued Aug. 17, 1993 uses a mechanical clamping system to attach to the ladder uprights and is locatable to only one side of ladder uprights in general. U.S. Pat. No. 2,056,527 to J E Kummer issued Oct. 6, 1936 uses the ladder rungs in general to support the ladder caddy devise to hold paint tins and is of one piece design.

U.S. Pat. No. 4,979,710 to D. Baldwin issued Dec. 25, 1990 similarly uses ladder rungs in general to support the paint tray and attaches to its ladder support bracket by means of a screw.

Lastly U.S. Pat. No. 3,822,847 to G. Emmons issued Jul. 9, 1974 provides a ladder tray, locatable to on one side of ladder uprights in general; the device is of one-piece design. The ladder tray is screw attached to its support bracket.

While the aforementioned prior art designs are more than adequate to fulfil their basic functions, it would be desirable to have a universal ladder caddy support bracket that self adjusts to single or double ladder extensions, which may be easily detached and moved to any location on either the left or right hand side of ladder uprights in general.

It is further desirable to have a ladder workstation that is not attached to it's ladder support bracket by means of screws or bolts, which when detached from it's ladder support bracket, will free stand on the ground. These are the stated objectives of the present invention.

### SUMMARY OF THE INVENTION

Briefly stated, the present invention comprises a ladder bracket to support a detachable ladder workstation, the workstation accepts removable rectangular inserts, which in turn hold rectangular liners and paint roller tray.

An important feature of the present invention resides in the ladder bracket which comprises two rectangular plates with upturned edges on their longest sides, these plates are joined together by two rods of differing sizes, the two rods being placed between the plates upturned edges to permit the bracket to be attached to a ladder uprights in general and so give support to the workstation.

The workstation is a one-piece rectangular wire framework, which incorporates a formed carrying handle.

The workstation holds two rectangular inserts, which in turn hold open, compartmented liners and paint roller tray. The liners will contain paint materials and various tools.

The weight of the workstation and any added materials cause the plates to compress against the ladder side rails and rung. The workstation will free stand on the ground.

The particular advantages and features of the present invention will become more readily apparent and understood from consideration of the accompanying drawings and detailed description.

### BRIEF DESCRIPTION OF THE DRAWINGS

The invention together with other objects and advantages will be better understood by reference to the following description, taken in conjunction with the accompanying drawings in which,

FIG. 1 is a front elevation view of the ladder workstation positioned on a ladder upright.

FIG. 2 is a side elevation view of the ladder workstation positioned on a standing ladder upright.

FIG. 3 is an enlarged view of the ladder workstation attachment bracket.

FIG. 4 is a left side and end view of the ladder workstation and insert.

FIG. 5 is a view of an open liner, a compartmented liner and a roller tray.

### DESCRIPTION OF THE PREFERRED EMBODIMENT

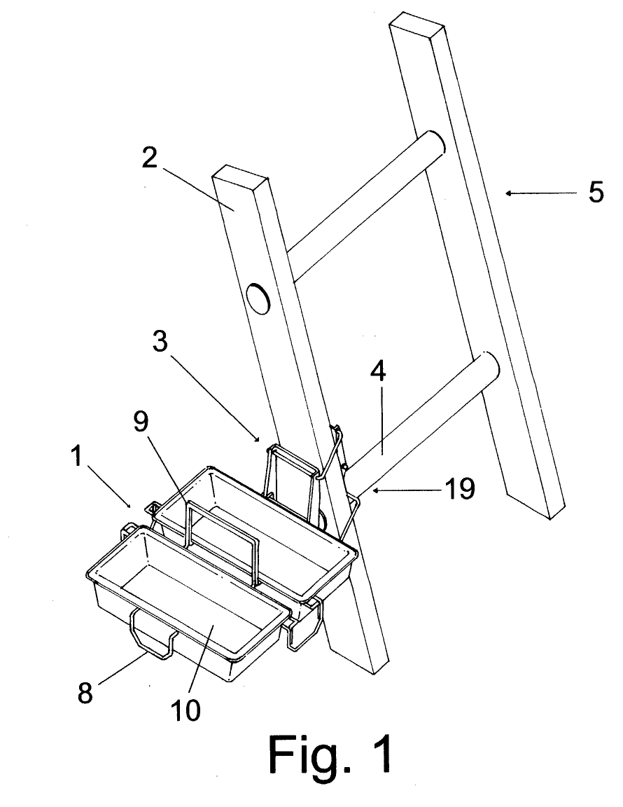

Referring in more detail to the drawings there is illustrated in FIG. 1. a ladder workstation shown generally at 1. attached to a ladder upright 2. by means of the self clamping action between the supporting bracket 3. and a ladder rung 4. induced by its own weight and the weight of any added materials. The ladder 5. is represented in an upright position as it would be against a wall and may be of single or double extension ladder or particular steps may be of aluminium, wood or carbon fibre construction, with rungs 3 being rounded, D shaped or stepped. A ladder upright 2. may be of solid construction, channelled or shaped

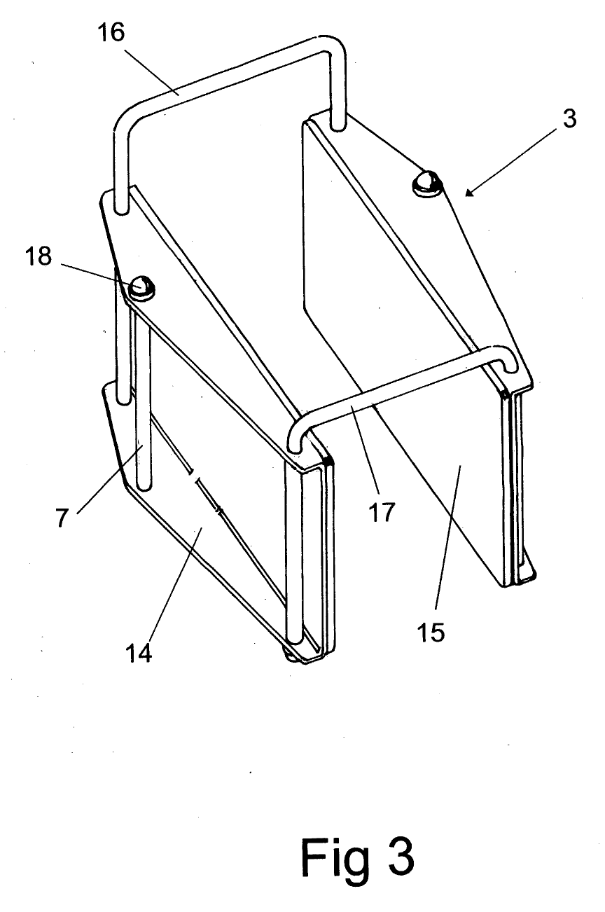

A ladder workstation 1. is attached to the ladder bracket 3. by means of locating into the holding pin, as shown in FIG. 3. 7. by means of any of its four legs FIG. 1.8.

The carrying handle FIG. 1.9. is for locating and relocating the workstation in any chosen position on the attachment bracket 3. or placement on the ground.

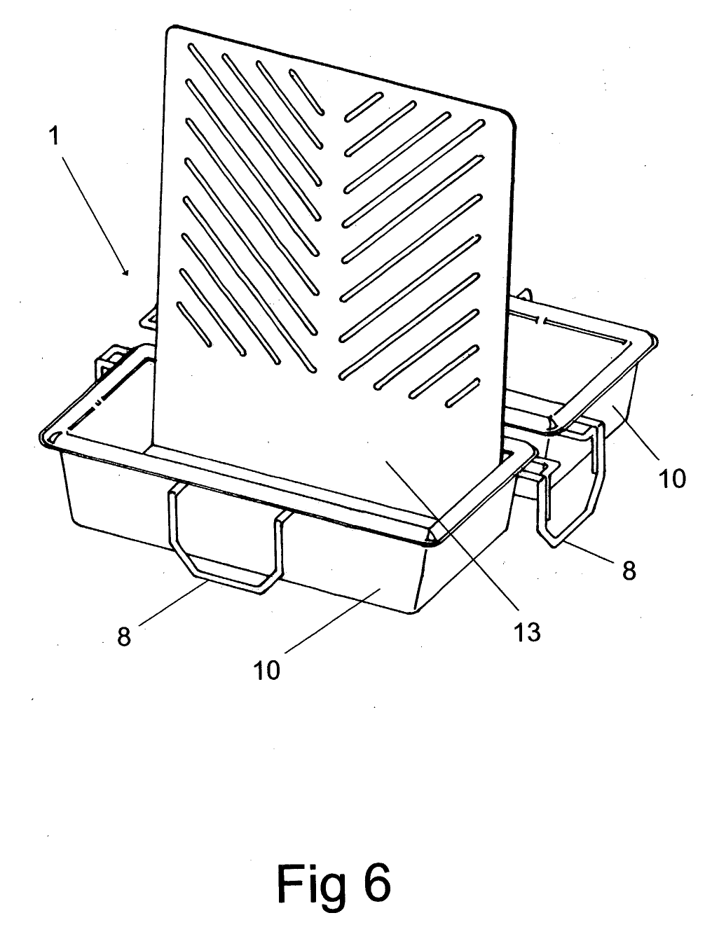

The ladder workstation 1. houses two removable rectangular insert trays 10. which are receptacles to generally receive working utensils or disposable liners FIG. 5. 11.& 12. These liners will generally contain paint materials and in the case of the liner 11. will house the paint roller tray FIG. 6. 13.

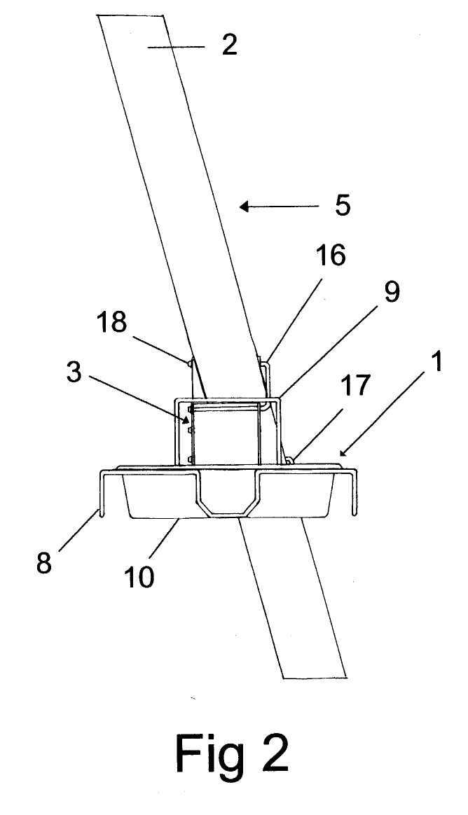

FIG. 2. Demonstrates the workstation 1. located on a ladder upright 2. in a 4/1 safe working position, by means of the ladder workstation attachment bracket 3. Now considering in more detail the construction of the workstation support bracket 3. comprising two rectangular shaped plates with upturned edges on their longest sides, as shown in FIG. 3.14. these plates are joined together by two loose fitting U shaped rods, as shown in FIG. 3. 16.& 17. the rods are attached to the plates 14. & 15. by means of locating holes where by the rods are pushed into the plates 14. & 15. and held by captive nuts as in FIG. 3. 18. as are the locating pins 7. The rods 16. & 17. allow the plates movement to compensate for the various widths of ladder uprights in general, as shown in FIG. 1. 19. the rods are of differing sizes, where as the rod 16. is larger than Rod 17. so as when located on a ladder upright 2. the rods compensate for the angle of the working ladder, where by rod 17. represents the top of the supporting bracket 3. and rod 16. represents the bottom of the supporting bracket 3. when the aforementioned bracket 3. is in a working location on a ladder upright 2. the workstation 4. is held in level agreement to the ground. The supporting bracket 3. can be located on the left or the right hand side of ladder uprights 2. and rungs 4.

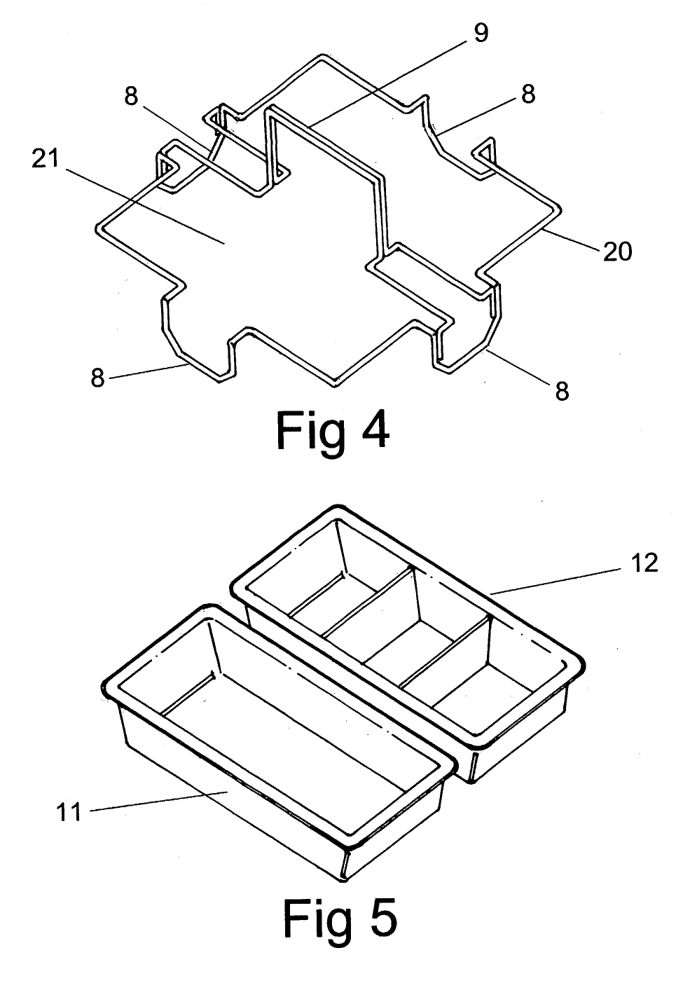

The workstation mainframe FIG. 4. 20. is preferred to be of wire form construction having shaped legs 8. positioned in the middle of each side of the frame 20. A carrying handle 9 and two rectangular bays 21. which house the removable trays 10. The trays 10. are of the same open rectangular feature, the trays in turn will accept rectangular liners, whereby 11. being an open rectangular insert liner of biodegradable or non-biodegradable material, similarly 12. being a rectangular compartmented liner of biodegradable or non-biodegradable material.

FIG. 6. 13. demonstrates a paint roller tray which is of biodegradable or non biodegradable material and attached to the workstation 1. by means of resting in the appropriate liner 11. whereby the main body of the tray is supported by the workstation handle 9. The liners 11.& 12. and roller tray 13. are of disposable bio-degradable or recyclable material and have the primary function of containing paint materials brushes and or paint rollers and associated tools. The liner 12. is divided into three compartments and the liner 11. is a single compartment. All trays and liners are interchangeable within the workstation mainframe.

FIG. 6. demonstrates the workstation 1. located in a level position such as the ground or floor.

Changes and modifications in the specifically described embodiments can be carried out without departing from the scope of the invention, which is intended to be limited only by the scope of the appending claims.

I claim:

1. A ladder workstation apparatus for releasable attachment to a side rail of a ladder, comprising a tray member of rectangular shape adapted to receive interchangeable rectangular inserts, the tray member having a plurality of elongated legs of equal length, any one of which is adapted to interlock releasably with a ladder attachment means comprising two parallel planar members linked together by parallel U-shaped members adapted to allow releasable engagement of the ladder attachment means with a side rail and a rung of a ladder.

2. A ladder workstation according to claim 1 wherein the ladder attachment means includes mid-way between the parallel U-shaped members means for releasably interlocking with the said any one of the tray legs.

3. A ladder workstation apparatus according to claim 1 wherein the U-shaped members are pivotally mounted in the said planar members thereby to facilitate the use of the apparatus with ladder side rails of different widths.

4. A ladder workstation according to claim 3 wherein the said planar members comprise rectangular plates of similar dimensions having their larger sides upturned, the said U-shaped members being located in the upturned edges of the rectangular plates.

5. A ladder workstation apparatus according to claim 4 wherein the means for releasably interlocking with the legs of the tray member comprises a rod mounted in the upturned edges of the rectangular plates and parallel to the U-shaped members.

6. A ladder workstation according to claim 1 wherein one of the U-shaped members has legs which are longer than those of the other U-shaped member, the relationship between the lengths of the legs of the U-shaped members being such that when the ladder to which the workstation apparatus is attached at its optimum working angle, the tray member is horizontal.

7. A ladder workstation apparatus according to claim 1 wherein the leg portions of the tray member are of equal length to facilitate the placement of the tray member on the ground.

8. A ladder workstation apparatus according to claim 1 wherein the tray member includes a central handle to facilitate the movement of the tray member from place to place.
